(19) United States
(12) Patent Application Publication
(10) Pub. No.: US 2012/0224978 A1
(43) Pub. Date: Sep. 6, 2012

(54) Apparatus and methods for adjustment of the pressure in a vehicle tire

(75) Inventors: Christoph FERBER, Novi, MI (US); Alexander WEBER, Gross-Gerau (DE); Dirk BALZER, Nierstein (DE)

(73) Assignee: GM GLOBAL TECHNOLOGY OPERATIONS LLC, Detroit, MI (US)

(21) Appl. No.: 13/405,401

(22) Filed: Feb. 27, 2012

(30) Foreign Application Priority Data
Mar. 3, 2011 (DE) 10 2011 012 946.4

(51) Int. Cl. F04B 49/00; B60C 23/04

(52) U.S. Cl. 417/44.1; 701/1

(57) ABSTRACT

An apparatus for adjusting the pressure in a tire of a vehicle comprises a compressed gas source, a coupling which can be fastened on a valve of the tire, and control means for selective action upon the coupling with compressed gas from the compressed gas source, said control means comprising an interface for communication with a TPM system.

### CROSS-REFERENCE TO RELATED APPLICATION

This application claims priority to German Patent Application No. 10 2011 012 946.4, filed Mar. 3, 2011, which is incorporated herein by reference in its entirety.

### TECHNICAL FIELD

The technical field generally relates to apparatus and methods for adjusting the pressure in a tire of a vehicle, in particular, of a motor vehicle.

### BACKGROUND

The most commonly used apparatus for adjusting the pressure of a tire of a vehicle at filling stations comprises in a portable unit a pressure container, a hose with a coupling for connection to a valve of the tire, a directional valve for connection of the hose as desired to the pressure container or to the surrounding atmosphere, and a pressure gage for detecting the pressure in the hose. When the coupling of this unit is fastened on the tire valve, the tire valve is open and the pressure gage measures the tire pressure. By actuating the directional valve of the unit, the user can bring the tire pressure to a desired value.

In order to be able to adjust the tire pressure correctly, the user must know the correct value. This is not always simple since the correct pressure on one and the same vehicle can be different between front and rear tire and possibly different types of tire can be used on the same vehicle, which each require different pressures. However, even when the correct pressure is known, the adjustment is a tedious process since the user cannot estimate exactly the amount of compressed air flowing in or out when opening the directional valve and the resulting change in the tire pressure.

Improved comfort is afforded by semiautomatic apparatus which give the user the possibility of inputting a desired tire pressure at a user interface, whereupon the apparatus takes over the adjustment of the pressure automatically. Here also the correct pressure can only be adjusted if the user knows it or can determine it correctly if necessary.

It is at least one object herein to provide apparatus and methods which improve the comfort for a user when adjusting the tire pressure or help to eliminate errors when adjusting the tire pressure. In addition, other objects, desirable features and characteristics will become apparent from the subsequent summary and detailed description, and the appended claims, taken in conjunction with the accompanying drawings and this background.

### SUMMARY

Many modern motor vehicles are fitted with so-called TPM (tire pressure monitoring) systems; in the US market these systems are prescribed. A TPM system usually comprises pressure sensors disposed on the tire of a vehicle and a central unit for displaying the detected pressure or a result derived from the detected pressure on a display instrument on the dashboard of the vehicle. In order to be able to warn the driver if the tire pressure is inadequate, the TPM system must know the correct desired pressure of the tire.

The various embodiments contemplated herein are based on the idea of utilizing this information when adjusting the pressure. In an exemplary embodiment, an apparatus for adjusting the pressure in a tire of a vehicle comprises a compressed gas source, a coupling which can be fastened on a valve of the tire, and control means for selective action upon the coupling with compressed gas from the compressed gas source The control means comprises an interface for communication with a TPM system.

In a simple embodiment of the apparatus, the interface can be adapted to receive a command for acting upon or not acting upon the coupling with the compressed gas or with atmospheric pressure from the TPM system. In other words, the TPM system makes the decision as to whether the tire pressure must be reduced or not and sends corresponding commands to the control means of the apparatus. The task of this control means is substantially restricted to executing the commands, e.g. by controlling a valve between the compressed gas source and the coupling when the compressed gas source is a pressurized container or switching on or off the compressed gas source when the compressed gas source comprises a compressor or the like.

The interface of the apparatus according to an embodiment can further be adapted to receive measured pressure values of a pressure sensor of the TPM system associated with the tire. Usage of the measured pressure values by the apparatus can be restricted to displaying these on a display instrument of the apparatus so that the user can track the adjusting process and can confirm its correct execution.

However, in another embodiment, the control means of the apparatus itself comprises a logic circuit, which is adapted to compare the received pressure values with a desired value and, depending on the result of the comparison, to act upon or not act upon the coupling with the compressed gas. Such an apparatus is certainly more complex than the afore-mentioned and receives explicit commands from the TPM system but can also cooperate with TPM systems which are only adapted to the apparatus contemplated herein to a small extent or not at all.

Such an apparatus then also enables a convenient adjustment of the tire pressure if the desired value of the tire pressure must be input by the user. The apparatus does not require its own pressure gage to function correctly since the adjustment of the pressure is based on the measured values of the pressure sensor of the TPM system. This constitutes a cost advantage not to be ignored in particular in apparatus for private use.

In order to utilize the potential of the TPM interface, the apparatus should be adapted to receive the desired value of the tire pressure from the TPM system. Since the apparatus takes into account the received desired value when adjusting the tire pressure, adjustment errors can be reliably avoided. In an exemplary embodiment, the apparatus has an interface adapted to receive the desired value from the TPM system and also a user interface for input of the desired value. This enables the apparatus to cooperate both with a TPM system adapted to it, which provides the desired value, and also with a conventional TPM system which does not do this. In addition, the user interface can permit the adjusting to a different tire pressure from the desired value specified by the TPM system, for example, if the user knows that the vehicle will shortly be heavily laden and then a higher tire pressure than the desired value presently specified by the TPM system will be required.

In one embodiment, the interface between the apparatus and the TPM system can be a hard-wired interface, e.g. a plug-in location on a data bus system inside the vehicle, e.g. of the LIN or CAN type. In an alternative embodiment, the interface is a cordless interface, which can be more convenient for the user.

In another embodiment, the interface is adapted to evaluate messages exchanged between a pressure sensor and a central unit of the TPM system. In particular, if the apparatus can evaluate messages of the pressure sensor, which necessarily specify the pressure detected by the pressure sensor, the central unit need not necessarily notify this pressure to the apparatus. Such listening in to messages by the interface of the apparatus is particularly simple to achieve if the pressure sensor and the central unit of the TPM system communicate with one another via cordless interfaces and the interface of the apparatus is compatible with that of the TPM system. The apparatus then can listen in to internal messages of the TPM system possibly without any adaptation of the TPM system.

In another embodiment, a TPM system comprises at least one pressure sensor for detecting the pressure of a tire of a vehicle and a central unit for displaying the detected pressure or a result derived from the detected pressure, for controlling an apparatus of the type described above for adjusting the pressure of a vehicle tire. In a further embodiment, TPM systems are specifically adapted for cooperation with a tire pressure adjusting apparatus

In order not to use unnecessary energy, the pressure sensors of conventional TPM systems are usually inactive when the vehicle is at a standstill, i.e., they do not send any messages to the central unit. Since the adjustment of the tire pressure takes place when the vehicle is at a standstill, it may be necessary to first activate a pressure sensor so that it sends the messages required to adjust the pressure. This can expediently take place whereby the pressure sensor can be activated by a fluctuation of the tire pressure which usually occurs when a tire pressure adjusting device is connected to the valve of the tire and thereby opens this.

As described above, an adaptation of the TPM system can include the TPM system having at least one interface for outputting the result derived from the detected pressure by the central unit and/or the detected pressure and/or a desired pressure to an external device. In an embodiment, this interface is cordless.

If the TPM system comprises a plurality of pressure sensors, the interface is preferably adapted to output the detected pressure, the desired pressure, and/or the derived result in relation to that pressure sensor at which a pressure fluctuation had been detected previously since the pressure adjusting device has obviously been connected to the tire associated with this pressure sensor.

In another embodiment, a method for adjusting the pressure in a tire of a vehicle includes:

reading a desired pressure of the tire out from a data memory of the vehicle;

transmitting the read desired pressure to control means of a compressed gas source (where this control means can be contained completely in a pressure adjusting device or can be distributed between the pressure adjusting device and a TPM system of the vehicle);

transmitting an actual pressure of the tire detected by a tire sensor to the control means; and

acting upon the tire with compressed gas from the compressed gas source until the actual pressure has reached the desired pressure.

If the desired pressures for different tires of the vehicle can be different, before performing the above steps, the tire connected to the compressed gas source can be determined and a specific desired pressure for the determined tire can be sought in the data memory.

### BRIEF DESCRIPTION OF THE DRAWINGS

The various embodiments will hereinafter be described in conjunction with the following drawing figures, wherein like numerals denote like elements, and wherein:

FIG. 1 is a schematic illustration of a vehicle on which a tire pressure adjusting device according to an exemplary embodiment is implemented;

FIG. 2 shows a flow diagram of an operating method of the pressure adjusting device according to an exemplary embodiment;

FIG. 3 shows an operating method of the pressure adjusting device according to another exemplary embodiment;

FIG. 4 shows an operating method of the central unit of the TPM system of the vehicle shown in FIG. 1; and

FIG. 5 shows an operating method of the central unit according to an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

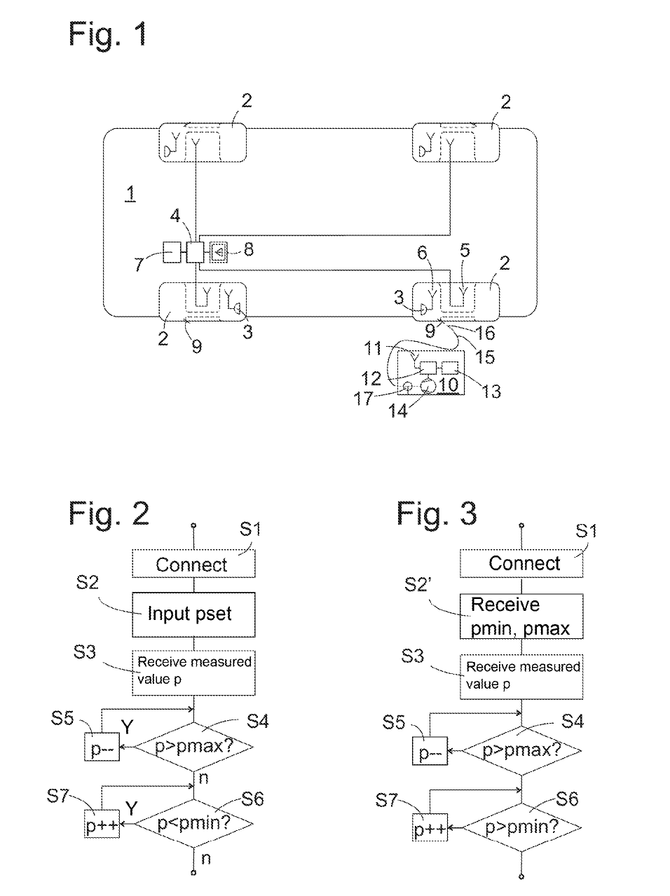

FIG. 1 shows a schematic diagram of a motor vehicle 1 with four tires 2, of which each is fitted with a tire pressure sensor 3. A central unit 4 is connected to the tire pressure sensors 3 via communication interfaces 5, 6 in order to receive measured pressure values from the tire pressure sensors 3, compare them with desired values stored in a memory 7, and display measured pressures on a display instrument 8 on the dashboard or, in the case of a significant deviation of a measured pressure from a desired value stored for the relevant tire or its sensor 3, display a warning. Since the tire pressure sensors 3 on the wheels 2 are brought in contact with the air chambers of their tires and rotate with these, in one embodiment, the communication interfaces 5, 6 are cordless, in particular radio interfaces such as are commonly used, for example, in RFID technology.

A tire pressure adjusting device 10 comprises in a portable housing a communication interface 11 compatible with the interfaces 5, 6, a control logic 12, an electronic display instrument 13, such as possibly a numeric LED or LCD display, and an electrically driven compressor 14. A pressure gage can be connected to the pressure output of the compressor in order to allow the pressure adjusting device 10 also to be used on a motor vehicle wheel that has no built-in pressure sensor or whose pressure sensor is destroyed. The pressure gage is not required for the pressure adjustment. A directional valve 17 connects a flexible hose 15 as desired to the pressure outlet of the compressor 14 or to the atmosphere. A coupling 16 at the free end of the hose can be fixed on a Schrader valve 9 of one of the wheels 2.

There are various possible operating modes of the tire pressure adjusting device 10, which differ in type and extent of their cooperation with the central unit 4 of the TPM system of the vehicle 1.

FIG. 2 describes an operating method of the control logic 12 that requires no assistance of the central unit 4 and therefore can also be implemented in conjunction with a conventional TPM system not adapted to the tire pressure adjustment device. In a first step S1 the coupling 16 is connected to the valve 9 of the wheel 2 to be adjusted. The valve 9 opens in a manner known per se, compressed air flows from the tire into the hose 15, which leads to a small but abrupt reduction of the pressure in the tire. This pressure reduction can be used as a trigger to switch the tire pressure sensor 3 from a state of readiness into an active state, in which it sends measured pressure values at short time intervals via its communication interface 6. These can be intercepted not only by the neighboring interface 5 of the central unit 4 but also by the interface 11 of the adjusting device 10 placed in the vicinity of the wheel 2 concerned.

In this embodiment, the adjusting device 10 has a user interface, e.g., in the form of a keypad, which enables the user to input a desired pressure pset in step S2. If the adjusting device 10 is fixedly associated with a specific vehicle as an accessory, it can also be expedient to provide a memory therein, in which a desired pressure input by the user remains stored for an arbitrarily long time between two adjusting processes so that it need not be input again every time. The user interface can have buttons which enable the user to make a selection between different desired pressure values stored for front and rear wheels 2 and/or to input the loading state of the vehicle 1 and thereby cause the control logic 12 to use the stored pressure value plus an increment as the desired pressure value pset under severe loading or to use a lower desired pressure value pset than the stored value under lower loading.

By reference to this desired pressure value, the control logic determines upper and lower limits pmax, pmin of the pressure to be adjusted at the tire, where pmin≦pset≦pmax=pmin +□, an □ can be an absolutely predefined constant.

In step S3 the control logic 12 receives via the interface 11 a measured value p sent by the activated tire pressure sensor 3. In step S4 the control logic compare compares this measured value with pmax. If the measured pressure p is higher than pmax, the control logic 12 opens the directional valve 17 to the atmosphere for a short time so that a small amount of air escapes from the tire into the open air (S5) and then repeats step S4.

If p is smaller than pmax, a comparison with pmin takes place in step S6. If p<pmin, the control logic 12 triggers the directional valve 17 in order to connect the compressor 14 to the tire for a short time and thus increase the tire pressure (S7) and then returns to S6. If it is determined in step S6 that p>pmin, the tire pressure is correctly adjusted and the method ends.

Since the control logic 12 continuously displays the pressure values p received from the pressure sensor 3 in the course of the method on the display instrument 13, the user can be sure that the pressure adjustment has been made correctly.

FIG. 3 shows another exemplary embodiment of the operating method of the control logic 12. This embodiment differs from the method of FIG. 2 in the manner in which the limiting values pmin, pmax of the tire pressure are specified in step S2′. As a result of this modification, the central unit 4 sends a message via one of its interfaces 5 which is associated with the wheel 2 to which the adjusting device 10 is connected, which message specifies the desired pressure pset or the limiting pressures pmin, pmax derived from this for this wheel 2. The limiting pressures pmin, pmax can be the same as those which produce a warning on the display instrument 8 when they are exceeded, but preferably the interval [pmin, pmax] is significantly smaller than the pressure range in which no warning is given. When determining pset or pmin, pmax, the central unit 4 can take into account various quantities influencing the tire pressure provided that appropriate sensors are provided for detecting this, such as, for example, the tire temperature or the loading state of the vehicle 1. The possibility of an unsuitable tire pressure being adjusted as a result of an accidently incorrect user input can in this way be almost completely eliminated.

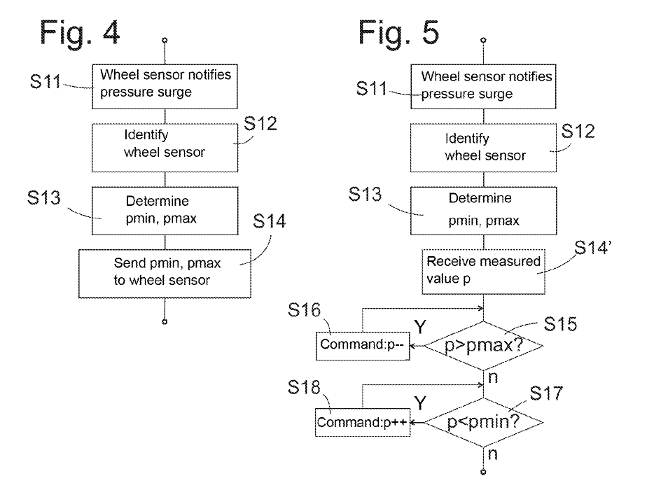

FIG. 4 illustrates the complementary operating mode of the central unit 4. If one of the tire pressure sensors 3 as described above is activated by the pressure surface which occurs when connecting the coupling 16, and begins to send measured pressure values p, these are received by the central unit 4 (S11). The central unit 4 identifies the tire pressure sensor 3 concerned, e.g. by means of a sender address (S12) transmitted together with the pressure values p, reads values of pset or pmin, pmax associated with this sensor 3 from the memory 7 (S13) and sends a message with these values via the interface 5 associated with the relevant sensor 3. The tire pressure sensor 3 cannot evaluate the message but it is received and evaluated by the adjusting device 10 as a result of the proximity of the adjusting device 10 to the relevant interface 5. In this context, it is irrelevant whether this message is only sent by one of the interfaces 5 or by all of the interfaces.

In an alternative embodiment, the central unit 4 merely detects by means of a message of one of the pressure sensors 3 that the tire pressure adjusting device 10 is connected but does not identify the wheel 2 at which this is the case. In this case, the central unit reads the pressure values for all the wheels 2 from the memory 7 and sends to each interface 5 those pressure values which are associated with the wheel 2 adjacent to the interface 5. The adjusting device 10 located on the wheel 2 to be adjusted thus receives the suitable pressure values for the intended adjustment process in each case.

FIG. 5 is a flow diagram of an operating method of the central unit 4 according to another embodiment of the invention, in which the TPM system is more strongly involved in the tire pressure adjustment than in the cases considered previously. Steps S11 to S13 are the same as described with reference to FIG. 4. Starting from the measured pressure values (S14′) transmitted in the usual manner per se from the tire pressure sensor 3 to the central unit 4, it is now the central unit 4 which in step S15 compares the measured pressure value p with pmax and if p>pmax, in step S16, sends a command for brief connection of the directional valve 17 to atmosphere to the adjusting device 10. This can be followed by a check to determine whether the command has actually led to a pressure reduction and if not, the central unit 4 generates an error warning, preferably in the form of an acoustic signal audible outside the vehicle 1.

If p≦pmax, the method reaches step S17, where a comparison with pmin takes place. If p<pmin, a command is issued to the adjusting device 10 to briefly connect the compressor 14 to the hose 15 (S18). Before the method returns to step S17, it can be checked here whether a pressure change has taken place and optionally generate a warning. The pressure is correctly adjusted and the method ends when p≧pmin.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An apparatus for adjusting the pressure in a tire of a vehicle comprising;
a compressed gas source;
a coupling configured to be fastened on a valve of the tire; and
control means for selective action upon the coupling with compressed gas from the compressed gas source-, wherein the control means comprises an interface for communication with a TPM system.

2. The apparatus according to claim 1, wherein the interface is configured to receive a command from the TPM system for acting upon or not acting upon the coupling with the compressed gas or with atmospheric pressure.

3. The apparatus according to claim 1, wherein the interface is configured to receive measured pressure values of a pressure sensor of the TPM system associated with the tire.

4. The apparatus according to claim 3, comprising a display instrument for displaying the measured pressure values.

5. The apparatus according to claim 3, wherein the control means further comprises a logic circuit, which is configured to compare the measured pressure values with a desired value and, depending on a result of the comparison, to act upon or not act upon the coupling with the compressed gas or atmospheric pressure.

6. The apparatus according to claim 5, wherein the interface is configured to receive the desired value from the TPM system.

7. The apparatus according to claim 1, wherein the interface is a cordless interface.

8. The apparatus according to claim 1, wherein the interface is configured to evaluate messages exchanged between a pressure sensor and a central unit of the TPM system.

9. A TPM system comprising:
a pressure sensor configured for detecting the pressure of a tire of a vehicle; and
a central unit for displaying the pressure detected from the pressure sensor or a result derived from the pressure detected from the pressure sensor for controlling a tire pressure adjustment apparatus comprising:
a compressed gas source;
a coupling configured to be fastened on a valve of the tire; and
control means for selective action upon the coupling with compressed gas from the compressed gas source, wherein the control means comprises an interface for communication with the TPM system.

10. A TPM system comprising:
a pressure sensor configured for detecting the pressure of a tire of a vehicle; and
a central unit for displaying the pressure detected from the pressure sensor or a result derived from the pressure detected from the pressure sensor, wherein the pressure sensor is activated by a fluctuation of the pressure of the tire in order to output the pressure detected from the pressure sensor.

11. A TPM system comprising:
a pressure sensor configured for detecting the pressure of a tire of a vehicle; and a central unit configured for displaying the pressure detected from the pressure sensor or a result derived from the pressure detected from the pressure sensor, wherein the central unit has at least one interface configured for outputting the result and/or the pressure and/or a desired pressure to an external device.

12. The TPM system according to claim 11, wherein the interface is a cordless interface.

13. The TPM system according to claim 11, wherein the TPM system comprises a plurality of pressure sensors and the interface is configured to output the pressure, the desired pressure, and/or the result in relation to that pressure sensor at which a pressure fluctuation had been detected previously.

14. A method for adjusting the pressure in a tire of a vehicle comprising the steps of:
reading a desired pressure of the tire out from a data memory of the vehicle;
transmitting the desired pressure to a control means of a compressed gas source;
transmitting an actual pressure of the tire detected by a tire sensor to the control means; and
acting upon the tire with compressed gas from the compressed gas source or with atmospheric pressure until the actual pressure has reached the desired pressure.

15. The method according to claim 14, further comprising the steps of:
determining the tire connected to the compressed gas source among several tires of the vehicle, and
seeking in the data memory a specific desired pressure for the tire connected to the compressed gas source.
